(19) United States
(12) Patent Application Publication
(10) Pub. No.: US 2015/0149335 A1
(43) Pub. Date: May 28, 2015

(54) COMMON AIR CONDITIONER OPERATING SYSTEM HAVING BILLING CALCULATION FUNCTION

(71) Applicant: Foundation of Industry-Academy Cooperation of University of Gachon, Seongnam-si (KR)

(72) Inventor: Sung-Yong SON, Seongnam-si (KR)

(21) Appl. No.: 14/523,041

(22) Filed: Oct. 24, 2014

(30) Foreign Application Priority Data
Nov. 24, 2013 (KR) 10-2013-0127285

(51) Int. Cl. G06Q 30/04; G06Q 50/06; G06Q 20/14

(52) U.S. Cl. CPC G06Q 30/04; G06Q 20/145; G06Q 50/06
USPC 705/34

(57) ABSTRACT

Provided is a common air conditioner operating system having a billing calculation function, including: at least one outdoor unit and a plurality of indoor units, at least one heat transfer unit, and a system operating apparatus configured to entirely control the above units, and calculate billing corresponding to use energy of each indoor unit, wherein the system operating apparatus sums a first amount obtained by multiplying a summed amount of a total heat production cost and a total heat transfer cost by a ratio of corresponding indoor unit supply heat sᵢ to a total supply heat S of all the indoor units, and heat supply costs of the corresponding indoor unit, and the total heat production cost is calculated by multiplying heat production energy, the total heat transfer cost is calculated by multiplying heat transfer energy, and the heat supply cost is calculated by multiplying heat supply energy.

### CROSS REFERENCES

This application claims foreign priority under Paris Convention to Korean Patent Application No. 10-2013-0127285, filed 24 Oct. 2013, with the Korean Intellectual Property Office, which is hereby incorporated by reference in its entirety into this application.

### BACKGROUND OF THE INVENTION

1. Field of the Invention

The present invention relates to a common air conditioner operating system having a billing calculation function capable of more reasonably adding billing by calculating billing for each indoor unit based on operating efficiency and operating costs at the time of a use of the common air conditioner, in the common air conditioner operating system driving at least one outdoor unit and a plurality of indoor units.

2. Description of the Related Art

An air conditioner means all the apparatuses which may cool, heat, ventilate, or purify indoor air, and may include an air conditioner which is mainly used for cooling, a heat exchanger which may be used for cooling and heating, or the like.

Further, the air conditioner generally includes an indoor unit and an outdoor unit, and the air conditioner generally using one indoor unit for one outdoor unit is more common. Recently, however, the common air conditioner operating system in which a plurality of indoor units are coupled with one outdoor unit or a plurality of indoor units are coupled with a plurality of outdoor units and are integrally operated has been widely used.

Generally, the common air conditioner operating system has been installed and operated in a building over a certain size, that is, a school, a public institution, a building, or the like, which has a plurality separated spaces to be cooled or heated.

Further, in many enterprises in which the common air conditioner of the related art is installed or a building in which different users are present, power costs for the use energy of the common air conditioner are simply calculated by dividing total power costs for the operation of the common air conditioner into 1/N, that is, proportionally dividing the total power costs into a total number of indoor units.

However, each indoor unit may have a different setting temperature and operating temperature depending on characteristics of each space and even though the set temperature is the same, a delivered quantity of heat may be different. Therefore, there is a need to add billing for energy amount actually used by each indoor unit.

Further, in the common air conditioner operating system, a load of the outdoor unit is determined depending on an operating configuration of the indoor unit, and when the number of operating indoor units is too many or few, efficiency of the outdoor unit is reduced. Therefore, even though the same quantity of heat is used, energy consumption may be different. Accordingly, in the common air conditioner operating system of the related art, uniform and equal billing allocation is unreasonable to specific consumers.

Furthermore, considering the situation in which the need for monitoring energy consumption and controlling an energy consumption target amount due to the change in environment such as a recent demand for energy saving, evolution to smart grid environment, or the like is growing, the method of equally allocating billing to the common air conditioner operating system of the related art may not be used as base data for saving of energy consumption.

### SUMMARY OF THE INVENTION

In consideration of the above-described circumstances, it is an object of the present invention to provide a common air conditioner operating system having a billing calculation function capable of more reasonably adding billing by calculating billing for each indoor unit based on operating efficiency and operating costs at the time of use of each indoor unit.

In order to accomplish the above objects, according to a first aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums a first amount, which is obtained by multiplying a summed amount of a total heat production cost C^{prod} generated from the outdoor unit and a total heat transfer cost C^{trans} generated from the heat transfer unit by a ratio of corresponding indoor unit supply heat sᵢ to a total supply heat S of all the indoor units, and heat supply costs cᵢ^{supply} of the corresponding indoor unit to calculate billing for each indoor unit, and performs billing calculation based on Equation

$${C}_{i} = ( {C}^{prod} + {C}^{trans} ) \times \frac{{s}_{i}}{S} + {c}_{i}^{supply} ,$$

and the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

According to a second aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total number

$$\frac{1}{{n}_{s}}$$

of indoor units to calculate billing for each indoor unit, and performs billing calculation based on Equation

$${C}_{i} = {C}^{prod} \times \frac{{s}_{i}}{S} + {c}_{i}^{supply} + \frac{1}{{n}_{s}} {C}^{trans} ,$$

and the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

According to a third aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total capacity ratio

$$\frac{{α}_{i}}{{\sum }_{j = 1}^{{n}_{s}} {α}_{j}}$$

of the indoor units to calculate billing for each indoor unit, and performs billing calculation based on Equation

$${C}_{i} = {C}^{prod} \times \frac{{s}_{i}}{S} + {c}_{i}^{supply} + \frac{{α}_{i}}{{\sum }_{j = 1}^{{n}_{s}} {α}_{j}} {C}^{trans} ,$$

and the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

According to a fourth aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total number

$$\frac{1}{{\sum }_{j = 1}^{{n}_{s}} {δ}_{j}}$$

of operating indoor units to calculate billing for each indoor unit, and performs billing calculation based on Equation

$${C}_{i} = {C}^{prod} \times \frac{{s}_{i}}{S} + {c}_{i}^{supply} + \frac{1}{{\sum }_{j = 1}^{{n}_{s}} {δ}_{j}} {C}^{trans} ,$$

and the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

According to a fifth aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total capacity ratio

$$\frac{{α}_{i}}{{\sum }_{j = 1}^{{n}_{s}} {δ}_{j} {α}_{j}}$$

of operating indoor units to calculate billing for each indoor unit, and performs billing calculation based on Equation

$${C}_{i} = {C}^{prod} \times \frac{{s}_{i}}{S} + {c}_{i}^{supply} + \frac{{α}_{i}}{{\sum }_{j = 1}^{{n}_{s}} {δ}_{j} {α}_{j}} {C}^{trans} ,$$

and the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

According to a sixth aspect of the present invention, there is provided a common air conditioner operating system having a billing calculation function, including: at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit, wherein the system operating apparatus sums heat production costs which are obtained by multiplying costs obtained by subtracting a total heat transfer cost C^{gap} according to a total heat difference from a total heat production cost C^{prod} by a ratio of supply heat sᵢ of the corresponding indoor unit to a total supply heat S, heat supply costs cᵢ^{supply} of the corresponding indoor unit, and heat transfer costs hᵢ(C^{gap}) of the corresponding indoor unit according to the heat difference to calculate billing for each indoor unit, and performs billing calculation based on Equation

$${C}_{i} = ( {C}^{prod} - {C}^{gap} ) \times \frac{{s}_{i}}{S} + {c}_{i}^{supply} + {h}_{i} ( {C}^{gap} ) ,$$

and the heat transfer cost C^{gap} according to the total heat difference is calculated as a heat difference G ratio between a total production heat P and a total supply heat for the total heat production cost C^{prod}, and is calculated based on Equation

$${C}^{gap} = {C}^{prod} \times \frac{G}{P} ,$$

and the total heat production cost C^{prod} is calculated by multiplying heat production energy generated to drive the outdoor unit by energy cost and the heat supply cost cᵢ^{supply} is calculated by multiplying the heat supply energy generated to drive the corresponding indoor unit by energy cost.

According to the present invention, the common air conditioner operating system may perform the reasonable billing processing for each indoor unit by adding billing to each indoor unit in consideration of the driving time and energy efficiency of the corresponding indoor unit in terms of the heat production energy and the heat transfer energy which are consumed to use each indoor unit.

Therefore, it is possible to minimize the consumer's dissatisfaction due to the unreasonable billing addition in the common air conditioner operating system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram schematically illustrating a configuration of a common air conditioner operating system according to a first embodiment of the present invention;

FIGS. 2A to 2C are diagrams for describing heat energy which is generated in the common air conditioner system illustrated in FIG. 1;

FIG. 3 is a diagram schematically illustrating an internal configuration of a system operating apparatus 400 illustrated in FIG. 1; and

FIG. 4 is a diagram schematically illustrating a billing information processing block of a billing processing unit 444 illustrated in FIG. 3.

### DETAILED DESCRIPTION OF THE INVENTION

Hereinafter, embodiments of the present invention will be described with reference to the accompanying drawings. However, those skilled in the art will appreciate that such embodiments are provided for illustrative purposes and do not limit subject matters to be protected as disclosed in the detailed description and appended claims. Therefore, it will be apparent to those skilled in the art that various alterations and modifications of the embodiments are possible within the scope and spirit of the present invention and duly included within the range as defined by the appended claims.

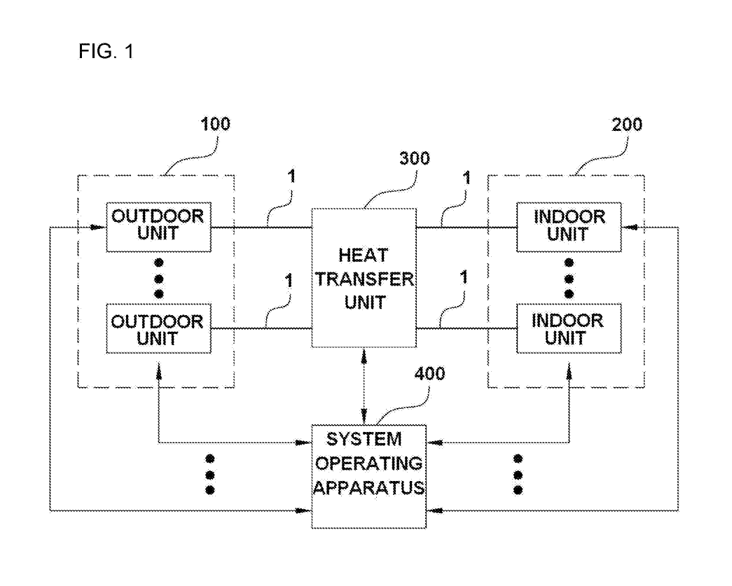

FIG. 1 is a diagram schematically illustrating a configuration of a common air conditioner operating system having a billing calculation function according to a first embodiment of the present invention.

As illustrated in FIG. 1, the common air conditioner operating system having a billing calculation function according to the present invention includes at least one outdoor unit 100 and a plurality of indoor units 200, a heat transfer unit 300 for selectively transferring production heat in a cooling/heating state generated from the outdoor unit 100 to the plurality of indoor units 200, and a system operating apparatus 400 calculating billing corresponding to use energy of each indoor unit 200, while entirely controlling the outdoor unit 100, the indoor unit 200, and the heat transfer unit 300.

In this case, a heat pipe 1 which transfers production heat for cooling/heating couples between the outdoor unit 100 and the heat transfer unit 300 and between the heat transfer unit 300 and each indoor unit 200.

Further, a plurality of outdoor units 100 are provided in consideration of the number of indoor units 200 and the use energy capacity thereof.

In addition, the indoor unit 200 may be configured to allow a user to turn on/off a power supply for selectively driving cooling/heating, and change a driving state such as temperature setting and airflow setting.

Further, the heat transfer unit 300 is configured to transfer production heat provided from the outdoor unit to each indoor unit 200. Although FIG. 1 illustrates one heat transfer unit 300, but one or more heat transfer units may be provided depending on the number of outdoor and indoor units 100 and 200. In this case, the heat transfer unit 300 may include a switch (not illustrated) for selectively supplying cooling/heating heat to the heat pipe 1 which is coupled with each indoor unit 200.

Further, although not illustrated, the outdoor unit 100, the indoor unit 200, and the heat transfer unit 300 include a power supply unit for providing energy to drive the corresponding apparatus, respectively.

Furthermore, the system operating apparatus 400 calculates billing for each indoor unit 200 based on driving state information and basic specification information which are provided from the outdoor unit 100, the indoor unit 200, and the heat transfer unit 300. Herein, the driving state information includes consumed energy amount information by driving time of the power supply unit (not illustrated) which is provided to drive each apparatus.

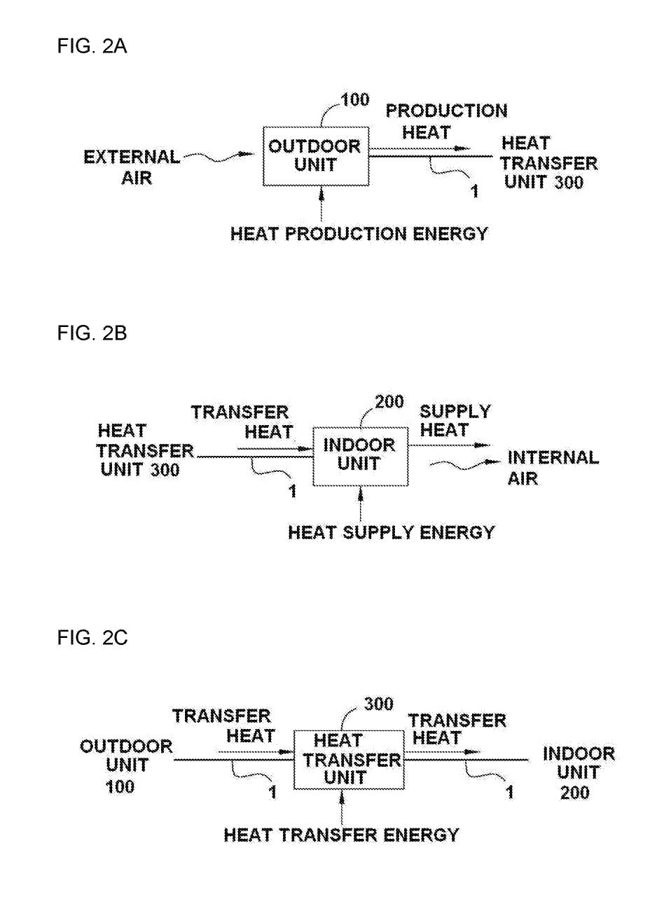

In this case, as illustrated in FIGS. 2A to 2C, the energy amount information generated from each apparatus may include heat production energy (FIG. 2A) which is generated to drive the outdoor unit 100, heat supply energy (FIG. 2B) generated to drive the indoor unit 200, and heat transfer energy (FIG. 2C) generated to drive the heat transfer unit 300. That is, the heat production energy is energy used for the outdoor unit 100 to convert external air into cooling/heating production heat, the heat transfer energy is energy used to provide the production heat introduced from the outdoor unit 100 to the indoor unit 200 through the heat pipe 1, and the heat supply energy is energy used for the indoor unit 200 to provide as internal air the production heat introduced from the heat transfer unit 300 through the heat pipe 1.

That is, the system operating apparatus 400 is configured to calculate cost by each use time by dividing the heat production energy, the heat transfer energy, and the heat supply energy depending on the supply of internal air by each indoor unit 200 and calculate billing for the corresponding indoor unit 200 based thereon. In this case, in calculating the billing, the system operating apparatus 400 may be configured to calculate billing by applying different costs depending on a total energy consumption of a billing period of time according to each time or the application of a progressive system to calculate the billing.

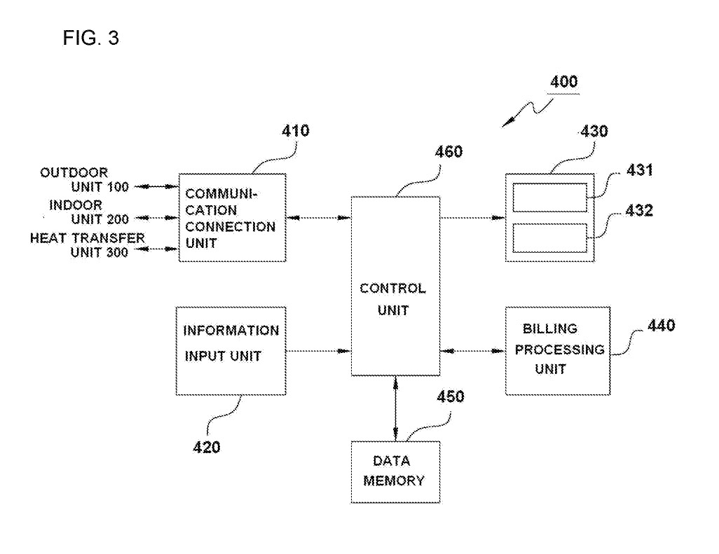

Meanwhile, FIG. 3 is a block diagram illustrating an internal configuration of the system operating apparatus 400 illustrated in FIG. 1 which is functionally divided.

As illustrated in FIG. 3, the system operating apparatus 400 includes a communication connection unit 410 for performing signal transmission and reception to and from the outdoor unit 100, each indoor unit 200, and the heat transfer unit 300, an information input unit 420 for inputting various types of common air conditioner related information, an information output unit 430 for outputting various types of common air conditioner related information, a billing processing unit 440 for performing billing processing depending on energy consumption for each indoor unit 200, a data memory 450 for storing various types of common air conditioner related information which is processed by the system operating apparatus 400, and a control unit 460 for generally controlling an operation of the system operating apparatus 400.

The information output unit 430 may include a display 431 for displaying the common air conditioner related information and a printer 432 for outputting the related information on a recording paper. For example, an operator monitors the driving state of each apparatus or inquires billing related information using a display 431 of the information output unit 430 and outputs the billing related information through the printer 432 to be distributed to users of each indoor unit 200.

Further, the system operating apparatus 440 calculates heat energy used in the outdoor unit 100, the indoor unit 200, and the heat transfer unit 300, and calculates billing for each indoor unit 200 based on the calculated heat energy.

Further, the data memory 450 stores the basic specification information on the outdoor unit 100, the indoor unit 200, and the heat transfer unit 300 and the driving state information provided from each apparatus. Herein, the basic specification information includes information on the total number of outdoor units 100, indoor units 200, and heat transfer units 300, the number of energy sources, and energy cost information according to each time/total consumption. Further, the driving state information includes consumed energy information and driving time information of each energy source (power supply unit) on the outdoor unit 100, the indoor unit 200, and the heat transfer unit 300. Further, the data memory 450 may store previously calculated billing history information on each indoor unit.

Further, the control unit 460 performs a control to store the basic specification information provided through the information input unit 420 and the driving state information provided from each apparatus through the communication connection unit 410 in the data memory 450 and controls the billing processing unit 440 to calculate the billing for each indoor unit 200 based on the billing related information stored in the data memory 450. In this case, the control unit 460 may be configured to convert the energy information in an analog state provided from each apparatus into numeric information which may be used in the billing processing unit 440 and store the converted numeric information in the data memory 450. Further, the energy information from each apparatus is converted into the numeric information and thus may be provided to the system operating apparatus 400.

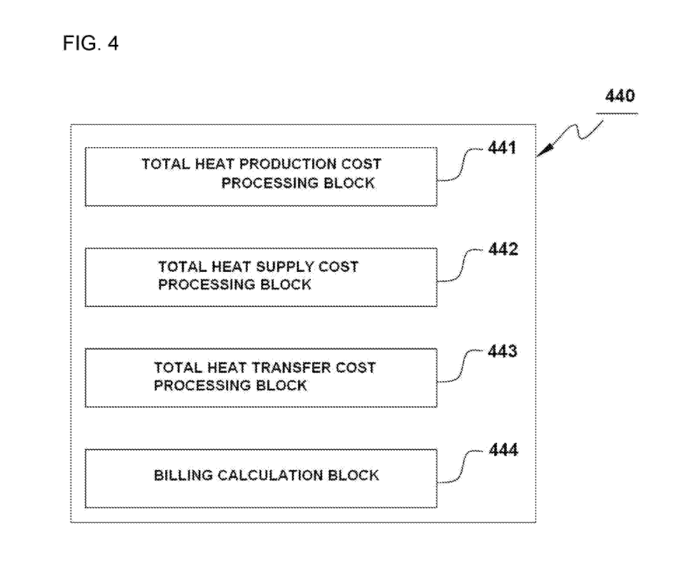

Meanwhile, FIG. 4 is a diagram schematically illustrating an information processing block of the billing processing unit 440 illustrated in FIG. 3.

As illustrated in FIG. 4, the billing processing unit 440 includes a total heat production cost processing block 441, a total heat supply cost processing block 442, a total heat transfer cost processing block 443, and a billing calculation block 444.

According to the present embodiment, the billing calculation processing is performed based on the following Equation considering the common air conditioner system which includes at least one of the outdoor unit 100, the indoor unit 200, and the heat transfer unit 300. Further, according to the present embodiment, the case in which a plurality of energy sources (power supplies) are coupled with each apparatus is considered.

First, each symbol is defined as follows in the following Equation.

The number of outdoor units: nₚ, the number of indoor units: nₛ, the number of heat transfer units: nₜ, the number of outdoor unit energy sources (power supplies): mₚ, the number of indoor unit energy sources (power supplies): mₛ, the number of heat transfer unit energy sources (power supplies): mₜ, production heat (heat produced from outdoor unit i): pᵢ, supply heat (heat supplied from indoor unit i): sᵢ, supply capacity (supply capacity of indoor unit i): αᵢ, heat production energy (consumed energy of power supply j for heat production in outdoor unit i) eᵢⱼ^{prod}, heat supply energy (consumed energy of power supply j for heat supply in indoor unit i): eᵢⱼ^{supply}, and heat transfer energy (consumed energy of power supply j for transferring production heat as consumption heat): eᵢⱼ^{trans}

First, the total heat production cost processing block 441 calculates a total cost consumed for all outdoor units 100 to produce heat by a certain time. In this case, the total heat production cost processing block 441 stores outdoor unit energy cost information in advance. In this case, the energy cost information may include energy, that is, energy cost which may be differently set according to each time or total energy consumption.

The following Equation 1 is a calculation equation of heat production costs cᵢ^{prod} for each outdoor unit 100 which are processed by the total heat production cost processing block 441.

$${c}_{i}^{prod} = {\sum }_{j = 1}^{{m}_{p}} {e}_{ij}^{prod} {u}_{j}^{prod} \qquad Equation 1$$

In the above Equation 1, uⱼ^{prod} means the energy cost of the outdoor unit 100.

That is, the total heat production cost processing block 441 calculates the heat production costs cᵢ^{prod} for each outdoor unit for a certain time by summing costs which are obtained by multiplying heat production energy eᵢⱼ^{prod} by energy cost uⱼ^{prod} for each of all the outdoor unit energy sources for the outdoor unit 100 i.

The following Equation 2 is a calculation equation of a total heat production cost cᵢ^{prod} by each corresponding time for all the outdoor units 100 which is processed by the total heat production cost processing block 441.

$${C}^{prod} = {\sum }_{i = 1}^{{n}_{p}} {c}_{i}^{prod} . \qquad Equation 2$$

In the above Equation 2, i={i, . . . , nₚ}

That is, the total heat production cost processing block 441 sums the total heat production cost cᵢ^{prod} for each outdoor unit 100 for a certain time to calculate the total heat production cost C^{prod} for the outdoor units for the corresponding time.

Meanwhile, the total heat supply processing block 442 calculates a total cost consumed for all the indoor units 200 to supply heat by a certain time. In this case, the total heat supply cost processing block 441 stores indoor unit energy cost information in advance. Herein, the energy cost information may include energy, that is, energy cost which may be differently set by each time or total energy consumption.

The following Equation 3 is a calculation equation of heat supply costs cᵢ^{supply} for each indoor unit 200 which are processed by the total heat supply cost processing block 442.

$${c}_{i}^{supply} = {\sum }_{j = 1}^{{m}_{s}} {e}_{ij}^{supply} {u}_{j}^{supply} \qquad Equation 3$$

In the above Equation 3, uⱼ^{supply} means the energy cost of the indoor unit 200.

That is, the total heat supply cost processing block 442 calculates the heat supply cost cᵢ^{supply} for each indoor unit for a certain time by summing costs which are obtained by multiplying heat supply energy eᵢⱼ^{supply} by energy cost uⱼ^{supply} according to each of all the indoor unit energy sources for the indoor unit 200 i.

The following Equation 4 is a calculation equation of a total heat supply cost C^{supply} by each corresponding time for all the indoor units 200 which is processed by the total heat supply cost processing block 442.

$${C}^{supply} = {\sum }_{i = 1}^{{n}_{s}} {c}_{i}^{supply} \qquad Equation 4$$

In the above Equation 4, i={i, . . . , nₛ}

That is, the total heat supply cost processing block 442 sums the total heat production cost cᵢ^{supply} for each indoor unit 200 for a certain time to calculate the total heat supply cost C^{supply} for the indoor unit for the corresponding time.

Meanwhile, the total heat transfer processing block 443 calculates the total cost consumed for all the indoor units 200 to supply heat by a certain time. In this case, the total heat transfer cost processing block 443 stores heat transfer unit energy cost information in advance. In this case, the energy cost information may include energy, that is, energy cost which may be differently set by each time or total energy consumption.

The following Equation 5 is a calculation equation of heat transfer costs c^{trans} for each heat transfer unit 300 which are processed by the total heat transfer cost processing block 443.

$${c}_{i}^{trans} = {\sum }_{j = 1}^{{m}_{t}} {e}_{ij}^{trans} {u}_{j}^{trans} \qquad Equation 5$$

In the above Equation 5, uⱼ^{trans} means the corresponding time energy cost of the heat transfer unit 300.

That is, the total heat transfer cost processing block 443 calculates the heat transfer costs c^{trans} for each heat transfer unit for a certain time by summing costs which are obtained by multiplying heat transfer energy eᵢⱼ^{trans} by energy cost uⱼ^{trans} according to each of all the heat transfer unit energy sources for the heat transfer unit 300.

The following Equation 6 is a calculation equation of a total heat transfer cost c^{trans} by each corresponding time for all the heat transfer units 300 which is processed by the total heat transfer cost processing block 443.

$${c}_{i}^{trans} = {\sum }_{j = 1}^{{m}_{t}} {e}_{ij}^{trans} {u}_{j}^{trans} \qquad Equation 6$$

In the above Equation 6, i={i, . . . , nₜ}

That is, the total heat transfer cost processing block 443 sums the total heat transfer cost c^{trans} for each heat transfer unit 300 for a certain time to calculate the total heat supply cost C^{trans} for the heat transfer unit for the corresponding time.

Meanwhile, the billing calculation block 444 performs the billing calculation processing for each indoor unit 200 by the following three methods.

1. Calculate Billing Based on Total Consumption Ratio

The billing calculation block 444 sums a first amount, which is obtained by multiplying a summed amount of the total heat production cost C^{prod} generated from the outdoor unit 100 and the total heat transfer cost C^{trans} generated from the heat transfer unit 300 by a ratio of corresponding indoor unit supply heat sᵢ to a total supply heat S of all the indoor units, and the heat supply cost cᵢ^{supply} of the corresponding indoor unit 200 to calculate the billing for each indoor unit 200. A billing calculation method depends on the following Equation 7. In this case, the billing calculation block 444 may calculate billing based on a method of calculating an amount for each indoor unit by time and then summing billing for a certain time.

$${C}_{i} = ( {C}^{prod} + {C}^{trans} ) \times \frac{{s}_{i}}{S} + {c}_{i}^{supply} \qquad Equation 7$$

2. Calculate Billing for Heat Transfer Cost in Consideration of Environment of Each Indoor Unit

The billing calculation block 444 sums a second amount which is obtained by multiplying the total heat production cost C^{prod} by a ratio of supply heat sᵢ of the corresponding indoor unit 200 to the total supply heat S, the heat supply cost cᵢ^{supply} of the corresponding indoor unit 200, and heat transfer cost fᵢ(C^{trans}) proportionally divided into the corresponding indoor unit 200 in consideration of environment to calculate billing for each indoor unit. The billing calculation method depends on the following Equation 8. In this case, the billing calculation block 444 may calculate billing based on a method of calculating an amount for each indoor unit by time and then summing billing for a certain time.

$${C}_{i} = {C}^{prod} \times \frac{{s}_{i}}{S} + {c}_{i}^{supply} + {f}_{i} ( {C}^{trans} ) \qquad Equation 8$$

In the above Equation 8, fᵢ(C^{trans}) is the heat transfer costs proportionally divided for the indoor unit i and as in Equations 9 to 12, may be calculated as costs which are obtained by proportionally dividing the total heat transfer cost by the total number

$$\frac{1}{{n}_{s}}$$

of indoor units (Equation 9), by proportionally dividing the total heat transfer cost by the total capacity ratio

$$\frac{{α}_{i}}{{\sum }_{j = 1}^{{n}_{s}} {α}_{j}}$$

of the indoor unit (Equation 10), by proportionally dividing the total heat transfer cost by the total number

$$\frac{1}{{\sum }_{j = 1}^{{n}_{s}} {δ}_{j}}$$

of operating indoor units (Equation 11), and by proportionally dividing the total heat transfer cost by the total capacity ratio

$$\frac{{α}_{i}}{{\sum }_{j = 1}^{{n}_{s}} {δ}_{j} {α}_{j}}$$

of operating indoor units (Equation 12).

$$\begin{matrix}{f}_{i} ( {C}^{trans} ) = \frac{1}{{n}_{s}} {C}^{trans} . & Equation 9 \\ {f}_{i} ( {C}^{trans} ) = \frac{{α}_{i}}{{\sum }_{j = 1}^{{n}_{s}} {α}_{j}} {C}^{trans} & Equation 10 \\ {f}_{i} ( {C}^{trans} ) = \frac{1}{{\sum }_{j = 1}^{{n}_{s}} {δ}_{j}} {C}^{trans} & Equation 11 \\ {f}_{i} ( {C}^{trans} ) = \frac{{α}_{i}}{{\sum }_{j = 1}^{{n}_{s}} {δ}_{j} {α}_{j}} {C}^{trans} & Equation 12\end{matrix}$$

In the above Equations, δ represents the operating state of the indoor unit 200 and has a value of “1” when the indoor unit 200 is operated for the corresponding time and has a value of “0” when the indoor unit 200 is not operated for the corresponding time.

3. Calculate Billing in Consideration of Heat Difference Cost

The billing calculation block 444 sums a fourth amount which is obtained by multiplying a third amount obtained by subtracting a total heat transfer cost C^{gap} according to a total heat difference from the total heat production cost C^{prod} by the ratio of supply heat sᵢ of the corresponding indoor unit 200 to the total supply heat S, the heat supply cost cᵢ^{supply} of the corresponding indoor unit 200, and a second heat transfer cost hᵢ(C^{gap}) proportionally divided into the corresponding indoor unit 200 in consideration of the heat difference to calculate billing for each indoor unit. The billing calculation method depends on the following Equation 13. In this case, the billing calculation block 444 may calculate billing based on a method of calculating an amount for each indoor unit by time and then summing billing for a certain time.

$${C}^{gap} = {C}^{prod} \times \frac{G}{P} \\ {C}_{i} = ( {C}^{prod} - {C}^{gap} ) \times \frac{{s}_{i}}{S} + {c}_{i}^{supply} + {h}_{i} ( {C}^{gap} ) \qquad Equation 13$$

In the above Equation 13, P represents the total production heat, S represents the total supply heat, and G is calculated by a difference between the total production heat and the total supply heat, that is, “G=P−S”.

Further, hᵢ(C^{gap}) is the heat transfer costs proportionally divided for the indoor unit i and as in Equations 14 to 17, may be calculated as costs which are obtained by proportionally dividing the heat transfer cost C^{gap} according to the heat difference by the total number

$$\frac{1}{{n}_{s}}$$

of indoor units (Equation 14), by proportionally dividing the heat transfer cost C^{gap} according to the heat difference by the total capacity ratio

$$\frac{{α}_{i}}{{\sum }_{j = 1}^{{n}_{s}} {α}_{j}}$$

of the indoor unit (Equation 15), by proportionally dividing the heat transfer cost C^{gap} according to the heat difference by the total number

$$\frac{1}{{\sum }_{j = 1}^{{n}_{s}} {δ}_{j}}$$

of operating indoor units (Equation 16), and by proportionally dividing the heat transfer cost C^{gap} according to the heat difference by the total capacity ratio

$$\frac{{α}_{i}}{{\sum }_{j = 1}^{{n}_{s}} {δ}_{j} {α}_{j}}$$

of operating indoor units (Equation 17).

$$\begin{matrix}{h}_{i} ( {C}^{gap} ) = \frac{1}{{n}_{s}} {C}^{gap} . & Equation 14 \\ {h}_{i} ( {C}^{gap} ) = \frac{{α}_{i}}{{\sum }_{j = 1}^{{n}_{s}} {α}_{j}} {C}^{gap} , & Equation 15 \\ {h}_{i} ( {C}^{gap} ) = \frac{1}{{\sum }_{j = 1}^{{n}_{s}} {δ}_{j}} {C}^{gap} , & Equation 16 \\ {h}_{i} ( {C}^{gap} ) = \frac{{α}_{i}}{{\sum }_{j = 1}^{{n}_{s}} {δ}_{j} {α}_{j}} {C}^{gap} & Equation 17\end{matrix}$$

In the above Equations, δ represents the operating state of the indoor unit 200 and has a value of “1” when the indoor unit 200 is operated for the corresponding time and has a value of “0” when the indoor unit 200 is not operated for the corresponding time.

That is, according to the embodiments of the present invention, the common air conditioner operating system adds billing for the heat production energy of the outdoor unit and the heat transfer energy of the heat transfer unit, which are used to drive the corresponding indoor unit, in consideration of the driving time and energy efficiency of the corresponding indoor unit, thereby performing the reasonable billing processing on each indoor unit.

Therefore, it is possible to minimize the consumer's dissatisfaction due to the unreasonable billing addition in the common air conditioner operating system.

What is claimed is:

1. A common air conditioner operating system having a billing calculation function, comprising:
at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit,
wherein the system operating apparatus sums a first amount, which is obtained by multiplying a summed amount of a total heat production cost C^{prod} generated from the outdoor unit and a total heat transfer cost C^{trans} generated from the heat transfer unit by a ratio of corresponding indoor unit supply heat sᵢ to a total supply heat S of all the indoor units, and heat supply costs cᵢ^{supply} of the corresponding indoor unit to calculate billing for each indoor unit, and performs billing calculation based on Equation
$${C}_{i} = ( {C}^{prod} + {C}^{trans} ) \times \frac{{s}_{i}}{S} + {c}_{i}^{supply} ,$$
and
the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

2. The common air conditioner operating system of claim 1, wherein the total heat production cost C^{prod} is calculated by heat production energy generated to drive the outdoor unit driven for driving time of the corresponding indoor unit by the energy cost and the total heat transfer cost C^{trans} is calculated by multiplying heat transfer energy generated to drive the heat transfer unit driven for the driving time of the corresponding indoor unit by the energy cost.

3. The common air conditioner operating system of claim 1, wherein the energy cost is differently set by each use time.

4. The common air conditioner operating system of claim 1, wherein the energy cost is differently set depending on total energy consumption for a billing period.

5. A common air conditioner operating system having a billing calculation function, comprising:
at least one outdoor unit and a plurality of indoor units, at least one heat transfer unit configured to selectively transfer production heat in a cooling/heating state generated from the outdoor unit to the plurality of indoor units, and a system operating apparatus configured to entirely control the heat transfer unit, the outdoor unit and the indoor unit, and the heat transfer unit, and calculate billing corresponding to use energy of each indoor unit,
wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total number
$$\frac{1}{{n}_{s}}$$
of indoor units to calculate billing for each indoor unit, and performs billing calculation based on Equation
$${C}_{i} = {C}^{prod} \times \frac{{s}_{i}}{S} + {c}_{i}^{supply} + \frac{1}{{n}_{i}} {C}^{trans} ,$$
and
the total heat production cost C^{prod} is calculated by multiplying heat production energy generated to drive the outdoor unit by energy cost, the total heat transfer cost C^{trans} is calculated by multiplying heat transfer energy generated to drive the heat transfer unit by the energy cost, and the heat supply cost cᵢ^{supply} is calculated by multiplying heat supply energy generated to drive the corresponding indoor unit by the energy cost.

6. The common air conditioner operating system of claim 5, wherein the total heat production cost C^{prod} is calculated by heat production energy generated to drive the outdoor unit driven for driving time of the corresponding indoor unit by the energy cost and the total heat transfer cost C^{trans} is calculated by multiplying heat transfer energy generated to drive the heat transfer unit driven for the driving time of the corresponding indoor unit by the energy cost.

7. The common air conditioner operating system of claim 5,
wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total capacity ratio
$$\frac{{α}_{i}}{{\sum }_{j = 1}^{{n}_{s}} {α}_{j}}$$
of the indoor units to calculate billing for each indoor unit, and performs billing calculation based on Equation
$${C}_{i} = {C}^{prod} \times \frac{{s}_{i}}{S} + {c}_{i}^{supply} + \frac{{α}_{i}}{{\sum }_{j = 1}^{{n}_{s}} {α}_{j}} {C}^{trans} .$$

8. The common air conditioner operating system of claim 5,
wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total number
$$\frac{1}{{\sum }_{j = 1}^{{n}_{s}} {δ}_{j}}$$
of operating indoor units to calculate billing for each indoor unit, and performs billing calculation based on Equation
$${C}_{i} = {C}^{prod} \times \frac{{s}_{i}}{S} + {c}_{i}^{supply} + \frac{1}{{\sum }_{j = 1}^{{n}_{s}} {δ}_{j}} {C}^{trans} .$$

9. The common air conditioner operating system of claim 5,
wherein the system operating apparatus sums a second amount which is obtained by multiplying the total heat production cost C^{prod} by a ratio of supply heat sᵢ of the corresponding indoor unit to the total supply heat S, heat supply costs cᵢ^{supply} of the corresponding indoor unit, and heat transfer costs obtained by proportionally dividing the total transfer cost C^{trans} by the total capacity ratio
$$\frac{{α}_{i}}{{\sum }_{j = 1}^{{n}_{s}} {δ}_{j} {α}_{j}}$$
of operating indoor units to calculate billing for each indoor unit, and performs billing calculation based on Equation
$${C}_{i} = {C}^{prod} \times \frac{{s}_{i}}{S} + {c}_{i}^{supply} + \frac{{α}_{i}}{{\sum }_{j = 1}^{{n}_{s}} {δ}_{j} {α}_{j}} {C}^{trans} .$$

10. The common air conditioner operating system of claim 5,
wherein the system operating apparatus sums heat production costs which are obtained by multiplying costs obtained by subtracting a total heat transfer cost C^{gap} according to a total heat difference from a total heat production cost C^{prod} by a ratio of supply heat sᵢ of the corresponding indoor unit to a total supply heat S, heat supply costs cᵢ^{supply} of the corresponding indoor unit, and heat transfer costs hᵢ(C^{gap}) of the corresponding indoor unit according to the heat difference to calculate billing for each indoor unit, and performs billing calculation based on Equation
$${C}_{i} = ( {C}^{prod} - {C}^{gap} ) \times \frac{{s}_{i}}{S} + {c}_{i}^{supply} + {h}_{i} ( {C}^{gap} ) ,$$
and
the heat transfer cost C^{gap} according to the total heat difference is calculated as a heat difference G ratio between a total production heat P and a total supply heat for the total heat production cost C^{prod}, and is calculated based on Equation
$${C}^{gap} = {C}^{prod} \times \frac{G}{P} ,$$
and
the total heat production cost C^{prod} is calculated by multiplying heat production energy generated to drive the outdoor unit by energy cost and the heat supply cost cᵢ^{supply} is calculated by multiplying the heat supply energy generated to drive the corresponding indoor unit by energy cost.

11. The common air conditioner operating system of claim 10, wherein the heat transfer cost hᵢ(C^{gap}) according to the heat difference for the corresponding indoor unit is calculated by proportionally dividing the heat transfer cost C^{gap} according to the total heat difference by the total number
$$\frac{1}{{n}_{s}}$$
of indoor units.

12. The common air conditioner operating system of claim 10, wherein the heat transfer cost hᵢ(C^{gap}) according to the heat difference for the corresponding indoor unit is calculated by proportionally dividing the heat transfer cost C^{gap} according to the total heat difference by the total number
$$\frac{{α}_{i}}{{\sum }_{j = 1}^{{n}_{s}} {δ}_{j}}$$
of operating indoor units.

13. The common air conditioner operating system of claim 10, wherein the heat transfer cost hᵢ(C^{gap}) according to the heat difference for the corresponding indoor unit is calculated by proportionally dividing the heat transfer cost C^{gap} according to the total heat difference by the total capacity ratio
$$\frac{{α}_{i}}{{\sum }_{j = 1}^{{n}_{s}} {δ}_{j} {α}_{j}}$$
of the indoor units.

14. The common air conditioner operating system of claim 10, wherein the heat transfer cost hᵢ(C^{gap}) according to the heat difference for the corresponding indoor unit is calculated by proportionally dividing the heat transfer cost C^{gap} according to the total heat difference by the total capacity ratio
$$\frac{{α}_{i}}{{\sum }_{j = 1}^{{n}_{s}} {δ}_{j} {α}_{j}}$$
of operating indoor units.

15. The common air conditioner operating system of claim 10, wherein the total heat production cost C^{prod} is calculated by heat production energy generated to drive the outdoor unit driven for driving time of the corresponding indoor unit by the energy cost.

16. The common air conditioner operating system of claim 10, wherein the energy cost is differently set by each use time.

17. The common air conditioner operating system of claim 10, wherein the energy cost is differently set depending on total energy consumption for a billing period.
